(19) United States
(12) Patent Application Publication
(10) Pub. No.: US 2014/0299394 A1
(43) Pub. Date: Oct. 9, 2014

(54) HYBRID VEHICLE WITH INTERNAL COMBUSTION ENGINE AND ELECTRIC MACHINE

(71) Applicant: Dr. Ing. h.c. F. Porsche Aktiengesellschaft, Stuttgart (DE)

(72) Inventors: Markus Goehring, Nufringen (DE); Martin Roth, Rutesheim (DE); Werner Huefner, Tiefenbronn (DE)

(73) Assignee: Dr. Ing. h.c. F. Porsche Aktiengesellschaft, Stuttgart (DE)

(21) Appl. No.: 14/244,101

(22) Filed: Apr. 3, 2014

(30) Foreign Application Priority Data
Apr. 3, 2013 (DE) 10 2013 103 305.9

(51) Int. Cl. B60K 6/44

(52) U.S. Cl. CPC B60K 6/44; Y10S 903/915
USPC 180/65.225; 903/915

(57) ABSTRACT

A hybrid vehicle (1) has an internal combustion engine (2), an electric machine (3) and a transmission (4) for driving a rear axle (5) of the vehicle (1). The internal combustion engine (2) and the electric machine (3) are assigned a common input shaft (6) of the transmission (4). The internal combustion engine (2), the electric machine (3) and a traction battery (19) for the electric machine (3) or a tank for the internal combustion engine (2) are arranged in a rear region of the vehicle (1), transversely with respect to the direction of travel. The electric machine power is greater than the power of the internal combustion engine (2). A high level of electrification of the hybrid drive is possible with optimum utilization of space in the vehicle.

### CROSS REFERENCE TO RELATED APPLICATION

This application claims priority under 35 USC 119 to German Patent Appl. No. 10 2013 103 305.9 filed on Apr. 3, 2013, the entire disclosure of which is incorporated herein by reference.

### BACKGROUND

1. Field of the Invention

The invention relates to a hybrid vehicle having an internal combustion engine, at least one electric machine and a transmission for driving a rear axle of a vehicle. The internal combustion engine and one electric machine are assigned a common input shaft of the transmission.

2. Description of the Related Art

A parallel hybrid vehicle has an internal combustion engine and an electric machine that act on a common drivetrain. Forces or torques of the internal combustion engine and the electric machine can be available simultaneously.

DE 10 2011 000 609 A1 discloses a parallel hybrid vehicle where the internal combustion engine, the electric machine and the transmission are installed in the longitudinal direction of the vehicle. The internal combustion engine is arranged in front of the electric machine, and the electric machine is arranged in front of the transmission. An extremely large structural space in the longitudinal direction of the vehicle is required proceeding forward from the rear axle due to the longitudinal arrangement of said assemblies. A further electric machine is provided for driving the wheels of a front axle of the vehicle.

US 2007/0137906 A1 describes a parallel hybrid vehicle where an axle that has two wheels is assigned a drivetrain that is arranged parallel to the axle and thus transverse to the direction of travel. The drivetrain is formed by an internal combustion engine, an electric machine and the transmission. The electric machine is connected via an energy converter to a traction battery.

DE 10 2007 044 526 A1 discloses a hybrid vehicle in the form of an industrial truck with a drive arranged transverse to the direction of travel. The drive assemblies are arranged between a front axle and a rear axle of the vehicle, and a traction battery is positioned behind the drive assemblies, and thus between the drive assemblies and the rear axle.

It is an object of the present invention to further develop a hybrid vehicle so that a high level of electrification of the hybrid drive is possible with optimum utilization of the structural space of the vehicle.

### SUMMARY OF THE INVENTION

The invention relates to a hybrid vehicle where the internal combustion engine, an electric machine and a traction battery for the electric machine or a tank for the internal combustion engine are arranged in a rear region of the vehicle, transversely with respect to the direction of travel, and wherein the electric machine power is greater than the power of the internal combustion engine.

The hybrid vehicle preferably is a sports car.

The transverse arrangement of the drivetrain results in a relatively large free structural space in the rear-end region, in particular in relation to known rear-engine sports cars with large internal combustion engine. The free structural space can be utilized for the relatively large electrical traction battery or for the tank if the traction battery is arranged in the front end of the vehicle. The unit composed of electric machine and internal combustion engine can be made extremely compact by having the electric machine power be greater than the power of the internal combustion engine. A sports car normally is driven by a large-displacement 6-cylinder or 8-cylinder engine. However, the hybrid sports car of the invention can use a small internal combustion engine, for example a 3-cylinder engine or compact 4-cylinder engine. The one electric machine is arranged in the structural space thus obtained in the rear-end region of the motor vehicle.

It is thus possible to resort to considerably cheaper and lower-powered conventional internal combustion engine drivetrains from front-wheel-drive mass-production vehicles or mass-production vehicle construction sets.

The internal combustion engine or the transverse installation may be in a horizontal arrangement. Thus, a low center of gravity is obtained, which is beneficial for a sports car. This also results in additional structural space above the transverse installation. It is also possible for the internal combustion engine or the transverse installation to be positioned in an arrangement that deviates from the horizontal arrangement. For example, the transverse installation could be provided in a vertical arrangement. An arrangement is also conceivable in which the installation position is inclined obliquely so that the engine is not in a horizontal plane parallel to the contact plane of the wheels, but in a plane arranged at an acute angle to the horizontal plane.

A further electric machine may be arranged in the front region of the vehicle for driving the front axle of the vehicle. The hybrid vehicle may be an all-wheel-drive vehicle having a hybrid drive for the rear axle and a purely electric drive for the front axle.

The further electric machine preferably is arranged in front of the front axle for reasons of weight distribution, efficiency and traction.

The vehicle has a traction battery for the further electric machine. The traction battery preferably is assigned both to the further electric machine and also to the electric machine that is arranged in the region of the rear axle of the vehicle.

The traction battery may be in the region of the rear axle of the vehicle, and preferably in front of the rear axle and in front of the internal combustion engine. The traction battery alternatively may be in the front end of the vehicle.

A tank for fuel for the operation of the internal combustion engine preferably is above the further electric machine in the front end of the vehicle or in front of the internal combustion engine in the rear region of the vehicle.

The traction battery can be charged by a connection to a fixed power supply network (plug-in hybrid).

The invention thus provides a hybrid vehicle, in particular a hybrid sports car, that can be constructed using mass-production drivetrains. This solves the problem that, specifically in the case of the hybridization of sports cars, there is a considerable structural space deficit because, aside from an internal combustion engine with tank and exhaust system, it is also necessary for an electric drive, traction battery and charging unit to be accommodated in a small structural space. The high level of installed electrical power provided in the hybrid vehicle makes it possible for the internal combustion engine to be decreased in size without a resulting driving performance disadvantage in relation to conventionally driven vehicles. Here, it is possible to resort to considerably cheaper and lower-powered conventional internal combustion engine drivetrains from front-wheel-drive mass-production vehicles or mass-production vehicle construction sets. For example in the case of a sports car that conventionally is driven by a large-displacement cylinder-type engine, it is possible in the case of the hybrid-driven variant to change to a small, mass-production vehicle drivetrain and to compensate the power deficit by a high-powered electric machine in the structural space thus gained. The installation space gained in front of the drivetrain provides sufficient space for a large traction battery in front of the rear axle. Thus, large required traveling ranges of the vehicle can be realized. The tank can be arranged in the front end of the vehicle above the further electric machine and, while maintaining the same traveling range, can be smaller than in a conventional vehicle. The luggage compartment volume in the front end of the vehicle and in the rear end of the vehicle substantially can be maintained with this arrangement. Those components that are most critical in the event of a crash, specifically the traction battery and fuel tank, are situated outside the immediate deformation zones. The entire drive concept can be implemented inexpensively on the basis of existing mass-production vehicles, with corresponding bodyshell modifications.

Further features of the invention will emerge from the appended drawings and from the description of the preferred exemplary embodiment depicted in the drawings, without the invention being restricted to the exemplary embodiment.

### BRIEF DESCRIPTION OF THE DRAWINGS

FIG. 1 shows the hybrid vehicle according to the invention, which is in the form of a sports car, in a schematic illustration as viewed from above.

FIG. 2 shows a three-dimensional view of the vehicle body of the hybrid vehicle, for the rear-end region and the floor assembly assigned to the vehicle passenger compartment.

### DETAILED DESCRIPTION OF THE PREFERRED EMBODIMENTS

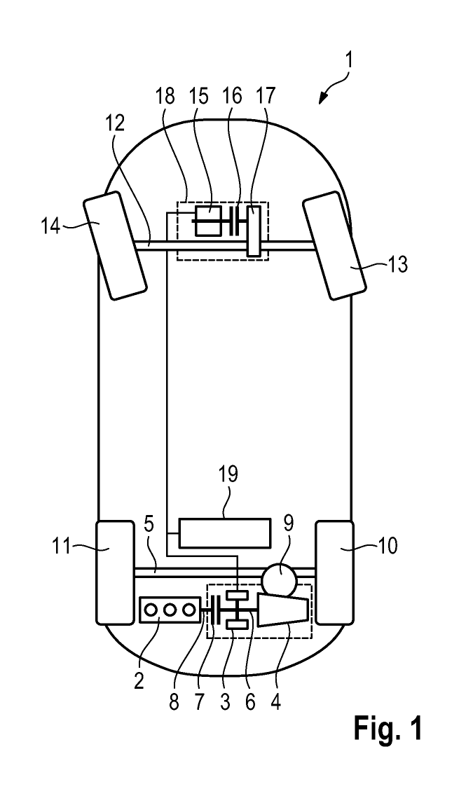

FIG. 1 illustrates the hybrid vehicle 1 having an internal combustion engine 2, an electric machine 3 and a transmission 4 for driving a rear axle 5 of the vehicle 1. Here, the internal combustion engine 2 and the electric machine 3 are assigned to a common input shaft 6 of the transmission 4. The input shaft 6 extends through the electric machine 3 and can be connected to a crankshaft 8 of the internal combustion engine 2 by means of a clutch 7. The transmission 8 is connected to the rear axle 5 via a differential 9. The rear axle 5 is assigned to a right wheel 10 and a left wheel 11 of the hybrid vehicle 1.

A front axle 12 is assigned steerable wheels 13 and 14. A further electric machine 15 is mounted in front of the front axle 12 and can be connected in non-positively locking fashion to the front axle 12 via a clutch 16 and a transmission 17. A tank 18 is arranged above the electric machine 15.

A traction battery 19 is installed in the region of the rear axle 5 of the vehicle 1 and is aligned transverse to the direction of travel. In this case the traction battery 19 is arranged in front of the rear axle 5.

The maximum power of the first electric machine is approximately 90 kW and the maximum power of the second electric machine also is approximately 90 kW. Furthermore the maximum power of the internal combustion engine is approximately 160 kW, in particular 162 kW. Such a level of power is generated for example by a 4-cylinder internal combustion engine with a displacement of 1.4 l. A tank for accommodating fuel for the internal combustion engine is arranged in the region of the front axle and thus in the region of the one electric machine. The tank has a volume of approximately 45 l.

The electric machine power, and thus the power of the two electric machines, is thus greater than the power of the internal combustion engine.

The internal combustion engine 2 preferably is substantially horizontal. Thus, the drivetrain formed from the internal combustion engine 2, the electric machine 3 and the transmission 4 has a low center of gravity, with performance advantages for the sports car. The internal combustion engine 2 takes up less structural space than the electric machine 3. The transverse arrangement of the drivetrain yields a relatively large free structural space in the rear-end region, with the structural space being utilized for the relatively large electric traction battery 19.

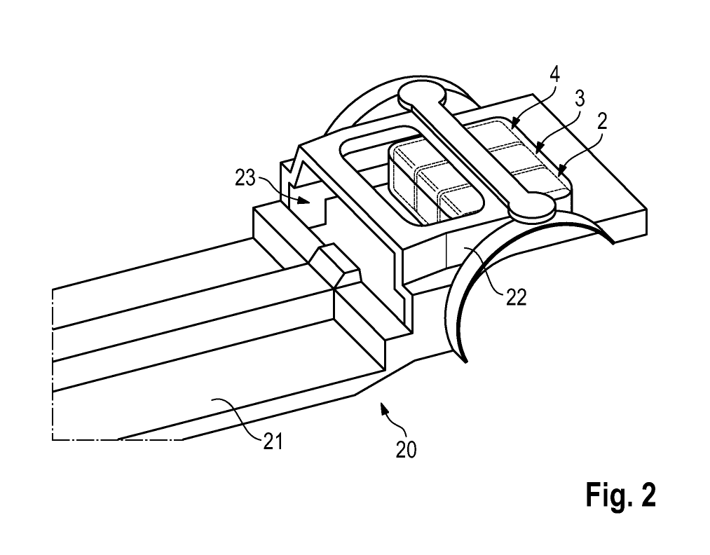

FIG. 2 illustrates a sub-region of a body 20 of the hybrid vehicle 1 that includes a floor 21 of the passenger compartment and a rear body region 22 of the hybrid vehicle 1. The drivetrain that has the internal combustion engine 2, the electric machine 3 and the transmission 4 is very far rearward in the hybrid vehicle 1. Thus, there is free structural space 23 in front of this drivetrain to accommodate the transversely positioned traction battery 19 or a fuel tank. The traction battery is arranged in the region of the front axle if the fuel tank is in the region 23.

The hybrid vehicle 1 also can have a connection to the fixed power supply network (plug-in).

What is claimed is:

1. A hybrid vehicle comprising: an internal combustion engine, at least one electric machine and a transmission for driving a rear axle of the vehicle, the internal combustion engine and the at least one electric machine being connectable to a common input shaft of the transmission, the internal combustion engine, the at least one electric machine and an energy store for the at least one electric machine or the internal combustion engine being arranged transverse to a direction of travel in a rear region of the vehicle (1), wherein power of the at least one electric machine is greater than power of the internal combustion engine (2).

2. The hybrid vehicle of claim 1, wherein the hybrid vehicle is a sports car.

3. The hybrid vehicle of claim 1, wherein the internal combustion engine takes up less space than the at least one electric machine.

4. The hybrid vehicle of claims 3, wherein the internal combustion engine is arranged substantially horizontally.

5. The hybrid vehicle of claim 3, wherein the internal combustion engine is a 3-cylinder engine or a 4-cylinder engine.

6. The hybrid vehicle of claim 1, wherein the at least one electric machine is a rear electric machine, the hybrid vehicle further comprising a front electric machine arranged in a front region of the vehicle for driving a front axle of the vehicle.

7. The hybrid vehicle of claim 6, wherein the front electric machine is in front of the front axle.

8. The hybrid vehicle of claim 7, wherein energy store is a traction battery for the rear and front electric machines.

9. The hybrid vehicle of claim 8, wherein the traction battery is arranged in a region of the rear axle of the vehicle.

10. The hybrid vehicle of claim 9, wherein the traction battery is in front of the rear axle and in front of the internal combustion engine.

11. The hybrid vehicle of claim 8, further comprising a tank for fuel for operating the internal combustion engine, the tank being arranged above the front electric machine.

12. The hybrid vehicle of claim 8, wherein the traction battery is configured to be charged by connection to a fixed power supply network.

13. The hybrid vehicle of claim 6, wherein the energy store comprises a tank for fuel for the internal combustion engine, the tank being arranged in a region of the rear axle and in front of the rear axle.

14. The hybrid vehicle of claim 6, wherein the electric machine power is approximately 180 kW and the internal combustion engine power is approximately 160 kW.

15. The hybrid vehicle of claim 14, characterized in that the power of the rear electric machine is approximately 90 kW and the power of the front electric machine is approximately 90 kW.
